(19) United States
(12) Patent Application Publication
(10) Pub. No.: US 2026/0116834 A1
(43) Pub. Date: Apr. 30, 2026

(54) Biodegradable Encapsulation of Fertilizer Salts for Controlled Release

(71) Applicant: Manoj Kumar Ram, Palm Harbor, FL (US)

(72) Inventor: Manoj Kumar Ram, Palm Harbor, FL (US)

(21) Appl. No.: 18/955,113

(22) Filed: Nov. 21, 2024

Related U.S. Application Data
(60) Provisional application No. 63/714,188, filed on Oct. 31, 2024.

(51) Int. Cl. C05G 5/35

(52) U.S. Cl. CPC C05G 5/35

(57) ABSTRACT

The invention described here-in includes the emulsion synthesis, processing, end-product and composition of encapsulated fertilizers and oils using alginate and select performance enhancing additives depending on the specific article's application. In some embodiments of the invention such as controlled fertilizer release, encapsulation longevity, fungal control, or insect repellency, the alginate-fertilizer and alginate-oil sponge are used as a slowly leaching and biodegradable capsule. The invention enables a mean for consumers to fertilize their plants without the addition of micro plastics to the soil, while acting as a mosquito repellent preventing the spread of arbo-viruses. The invention described here-in includes use of a mixture or individual additives: clay, calcined clay, cellulose, carboxymethyl cellulose and/or sodium polyacrylate used as thickeners and filler. Clays and calcined clays are used for their high surface area, adsorption and absorption properties, storing fertilizer for long term release, and adding structural integrity to the capsule.

### REFERENCE TO RELATED APPLICATION(S)

This application claims priority to U.S. Provisional Patent Application No. 63/714,188, filed on Oct. 31, 2024, the entire contents of which are fully incorporated herein by reference.

### STATEMENTS REGARDING FEDERALLY SPONSORED RESEARCH

Not applicable.

### REFERENCE TO A SEQUENCE LISTING

Not Applicable

### FIELD OF THE INVENTION

The invention is about the encapsulating biodegradable sponge on fertilizer using emulsion chemistry of alginate and nano-composite media. The invention is about the emulsion synthesis, processing, end-product and composition of encapsulated fertilizers and oils using alginate and select performance enhancing additives depending on the specific article's application.

### BACKGROUND OF THE INVENTION

The invention described here-in is biodegradable fertilizer encapsulating sponge and synthesis thereof using emulsion chemistry of alginate and nano-composite media.

It is clear to an artisan in the field of encapsulation of fertilizing substances using alginate or other gelling media, that the present invention described here-in may be performed with any nonpolar “oil” chemical whether hydrocarbons or lipids and their constituents (proteins, waxes), or any fertilizing salt, whether being is solid form or dissolved in liquid, so long as a stable emulsion is produced and proper chelation techniques are employed.

The invention presents select nano-additives and drying techniques which are used for enhancing select physical, chemical, and thermal properties of the capsules depending on their anticipated consumer application: controlled fertilizer release, encapsulation longevity, fungal control, or insect repellency.

Alginate is a polysaccharide commonly found in brown algae which consists of β-D-mannuronic acid and α-L-guluronic acid. Alginate possesses a linear chain structure of (1-4)-linked b-D-mannuronic acid (M) and α-L-guluronic acid (G) units, providing its hydrophilicity, biocompatibility, and nontoxicity. These blocks are arranged into three different polymer segments, consisting of (M) blocks, segments consisting entirely of α-L-guluronic acid (G) blocks and segments consisting of alternating (G/M) blocks (FIG. 1).[1] The linear chain structure of alginate proportions of β-D-mannuronic acid and α-L-guluronic acid vary, depending on algal species (FIG. 2) [2]. Alginate with monovalent ion (alkali metal or ammonium) is soluble; however, with divalent cations will chelate via the carboxylic groups to form hydrogels [3]

The ‘egg-box’ model of is generally invoked to explain how the divalent metal ions, bounded in the interchain cavities, give rise to solidification of a porous, cross-linked alginate gel complex (FIG. 3). Cross-linked alginate hydrogel beads are hydrophilic polymers which are highly water swollen. Calcium is the most frequently used divalent cation used for the preparation of alginate beads in a wide range of applications[4]. Alginate is commonly used for a variety of applications as a thickener, stabilizer, gel, capsule coating, and emulsifier, among others. The invention here in relies on the slow addition with continuous mixing and emulsification of hydrophobic or lipophilic oil with the raw alginate solution. The alginate solution discussed here-in can be mixed with most common fertilizers and fertilizer solutions which are not limiting such as urea, diammonium phosphate and potassium chloride, etc. It also can be emulsified with a variety of oils which are not limiting, such as andiroba oil, copaiba oil, olive oil, peanut oil, sunflower oil, eucalyptus oil, citronella oil, lavender oil, peppermint oil, lemongrass oil, etc. The ‘egg-box’ formation is then achieved after emulsion preparation through initiating alginate chelation and subsequent encapsulation of these fertilizers and oils (FIG. 4). Homogenously dispersed oil-alginate and fertilizer-alginate sponges are then produced which have unique attributes: preventing phase separation of the oils, controlled oil and fertilizer leaching and biodegradability [5-8]. Depending on the desired application for the produced sponges, whether for controlled fertilizer release, encapsulation longevity, fungal control, or insect repellency, industry select state-of-the-art additives are employed for performance innovation.

Given the unique emulsification and chelation properties of alginate with fertilizers, hydrophobic and lipophilic oils, encapsulated biodegradable controlled release fertilizer and mosquito repellent capsules are created. Biodegradable controlled release fertilizer encapsulation is advantageous when compared to polymer-based encapsulations given that microplastics in soils can impede the growth and development of plants while obstructing the transport of essential nutrients and water. Additionally, the collective effects of microplastics could alter soil architecture through physicochemical changes, consequently affecting water cycling, ecosystem functions, and plant-soil feedback in terrestrial systems [9].

Microplastics can infiltrate agricultural soils through various pathways, including irrigation water, organic compost, mulch film, soil modifiers, and atmospheric deposition. Interestingly, the residual coating of controlled-release fertilizers (CRF) has been overlooked as a source of microplastic contamination. CRFs are coated or encapsulated fertilizers, where the release is dictated by a porous polymer coating that contains a water-soluble fertilizer. Currently coatings are made of acrylic resins, polyethylene, waxes, and sulfur. The two main types of common resins used are the alkyd-type resins (e.g., Osmocote) and polyurethane-like coatings (e.g., Polyon). The release of nutrients from the prills (coated fertilizer spheres) is controlled mainly by the thickness of the coating and the temperature. With a thickness ranging from 10-80 μm and a diameter less than 5 mm, the CRF coating aligns with the definition of microplastics. The escalating consumption of CRF has led to an increase in microplastics from the residual coating in farmland soils. Upon application to soils, the residual coating undergoes fragmentation and degradation into smaller fragments through physical, chemical, and biological processes [9].

Alternatively to layering solid fertilizer with plastic coatings, this technology implements a sponge like structure to the encapsulated spheres, where fertilizer crystals are stored and can be slowly washed out by water. The inner porous structure is comprised of sodium alginate, bentonite clay, and cellulose. This technique allows the fertilizer to be mixed with the alginate solution, which when in contact with the calcium chloride bath fully chelates and entraps the fertilizer in the matrix (FIG. 5). Since the sphere has no differentiation between the inner core and the surface layer it is expected that the diffusion rate of fertilizer to be smaller than if it had a core and a shell. The diffusion rate can be controlled by changing the alginate solution concentration and the number of cross-linkers/fillers, which would change the size and shape of the micro pores.

A porous coating surrounds a water-soluble fertilizer (FIG. 6). Water penetrates the coating and slowly dissolves the encapsulated fertilizer increasing the osmotic pressure, which in turn increases the diffusion of the fertilizer outwards. The diluted fertilizer exits the capsule through the micro pores into the substrate, and into the plant (FIG. 7). The main parameters that dictate the release are, temperature, the composition and thickness of the coating, the fertilizer composition, and the concentration differential between the inside and outside of the capsule. However, the most important factors are coating thickness and temperature. As for rate of release depends on the concentration differential between the interior and exterior, among other things. As the concentration inside the capsule decreases over time, so does the rate of release of fertilizers.

Porosity of CRF has been enhanced by using clays and calcined clays as additives (smectite group, fullers earth, kaolin group, etc.), but their very high surface area, nano-platelet geometry. Bentonite clay (BC) has been found to be the most effective filler aiding on capsule porosity. Bentonite is an absorbent natural smectite clay characterized by a colloidal structure when dispersed in water. Each smectite particle is comprised of several submicroscopic platelets arranged in a stacked formation, with interstitial layers, which can be filled with water, separating the platelets. Each individual platelet has a thickness of approximately 1 nanometer and a lateral dimension extending up to several hundred nanometers. The planar surfaces of these platelets exhibit a net negative charge, while the edges possess a slight positive charge. The overall negative charge of the platelet is predominantly neutralized by sodium ions. These charge-balancing ions are associated with the platelet surfaces and are referred to as “exchangeable” due to their ability to be readily replaced by other cations.

The creation of repellents that are both effective and safe against arthropods is of great importance due to the lack of efficient vaccines against arboviruses (arthropod-borne viruses) and parasites. Arboviruses and parasites are transmitted to humans through arthropods, primarily mosquitoes, which are diseases carriers such as dengue, malaria, and yellow fever. Extensive research has been to manufacturing repellents that can effectively deter arthropods, with synthetic products being predominantly employed thus far. However, the widespread use of synthetic repellents has raised concerns regarding potential risks to environmental and human health. Consequently, plant essential oils (EOs) have emerged as a viable alternative to synthetic repellents.

Currently, the most prevalent mosquito-borne illness in the United States is caused by the West Nile virus (WNV), an arbovirus transmitted to humans by Culicine mosquitoes [11,12]. In 2017, the Center for Disease Control (CDC) reported 2,002 cases of WNV infections resulting in 121 deaths across the US. Despite this, there are currently no vaccines or medications available for preventing or treating WNV. Whereas Dengue fever has seen a significant global surge in recent decades, with an approximately 30-fold increase worldwide [13]. About 40% of the global population is at risk of dengue infection, resulting in 50-528 million cases annually and approximately 10,000-20,000 deaths [14, 15]. Lyme disease, transmitted by ticks, is highly prevalent in the United States and Europe. According to the CDC, approximately 300,000 people in the United States and 65,000 people in Europe are affected by tick-borne Lyme disease each year [16, 17].

Essential oils (EOs) consist of intricate blends of volatile organic compounds derived from plants, with their repellent properties primarily attributed to the presence of monoterpenoids, sesquiterpenes, and alcohols [18, 19]. Among the common constituents of EOs known for their repellent effects are citronellol, citronellal, α-pinene, and limonene [20, 21]. Recent research has revealed that linalool, a naturally occurring terpene alcohol found in various flowers and spice plants, as well as eucalyptol, a natural organic compound, activate the odorant receptor neuron in a mosquito's antennal sensilla [22, 23]. This discovery suggests the potential of an odor-sensing repellent screen platform as a novel strategy for developing repellents or compounds with innovative modes of action against arthropods.

Various methods have been proposed to enhance the repellent efficacy of EOs, with the most cited approach being the combination of multiple EOs from different plant sources to achieve a synergistic effect [24-29]. Studies have demonstrated that this synergistic utilization of diverse components yields greater repellent activity compared to individual components. For instance, a mixture of sesquiterpenes and monoterpenes from different EOs was found to significantly enhance the repellent effect, comparable to the combined effect of the individual components [26]. Furthermore, certain EOs such as citronella, lemon, and eucalyptus oils are widely recognized insect repellents, registered by the EPA and approved for topical use in humans. Of note, PMD (p-menthane-3,8-diol), deemed safe for human health, stands out as the sole plant-based repellent recommended by the CDC for public use [27].

As a form to mitigate the spread of Arbo-viruses, EO's can be encapsulated using porous biodegradable polymers, which allow for controlled diffusion into the air. The encapsulated EO can be dispensed on the soil near the plants, or on the plant vase acting as a continuous mosquito repellent scent dispenser (FIG. 8). Sodium alginate can be used to emulsify EO's and chelate in a porous sphere, creating an oil impregnated sponge like structure (FIG. 9). Furthermore, the addition of lavender, eucalyptus, peppermint, and lemongrass essential oils act as an antifungal and insect repellent [27], assisting on the preservation of the capsules and deterring pest flies.

The added essential oils are perfectly fit for personal gardens, allowing the plants to repel pest flies and disease carrying mosquitos. Citronella interferes with the sensory receptors of insects, particularly mosquitoes. The compounds found in citronella oil, such as citronellal and geraniol, disrupt the insects' ability to detect carbon dioxide, heat, and other chemical signals that lead them to their hosts. This confusion hinders their ability to find and bite humans or animals. The specific compounds present in citronella oil can cause irritation to insects upon contact. When insects encounter citronella, it may disrupt their feeding or landing behavior, discouraging them from staying in the vicinity. The repellency effect of citronella can discourage pests from landing on the skin or the plant, reducing the likelihood of bites and pests.

### SUMMARY

The invention described here-in includes the emulsion synthesis, processing, end-product and composition of encapsulated fertilizers and oils using alginate and select performance enhancing additives depending on the specific article's application. In some embodiments of the invention such as with encapsulation for controlled fertilizer release, encapsulation longevity, fungal control, or insect repellency, the alginate-fertilizer and alginate-oil sponge are used as a slowly leaching and biodegradable product. Examples of fertilizer which may be mixed and encapsulated in alginate using the proposed techniques include but are not limiting to urea, diammonium phosphate, potassium chloride, and commercial fertilizer solutions. Additionally, examples of oils which may be emulsified and encapsulated in alginate using the proposed techniques include but are not limiting to essential oils, vegetable oils, paraffins, pharmaceutical oils, plant extract, processed plant-based oils, cosmetic topical oils, other lipids. Embodiments of the invention described here-in includes use of a mixture or individual additives: clay, calcined clay, bentonite clay, carboxymethyl cellulose (CMC), and/or sodium polyacrylate (PA). CMC and PA are primarily used as thickeners and filler. Clays and calcined clays are used for their high surface area, adsorption and absorption properties, storing fertilizer for long term release, and adding structural integrity to the capsule.

### BRIEF DESCRIPTION OF THE DRAWINGS

FIG. 1. Alginate building blocks.

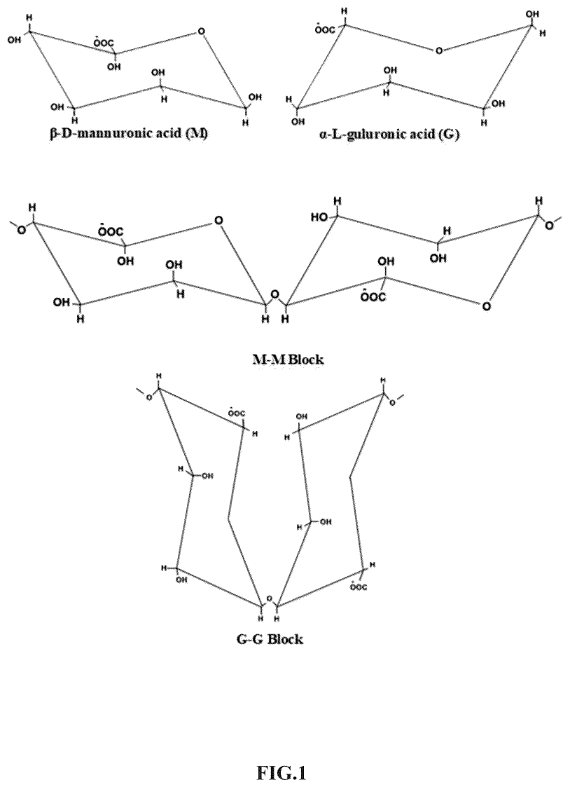

FIG. 2. Linear structure of Alginate.

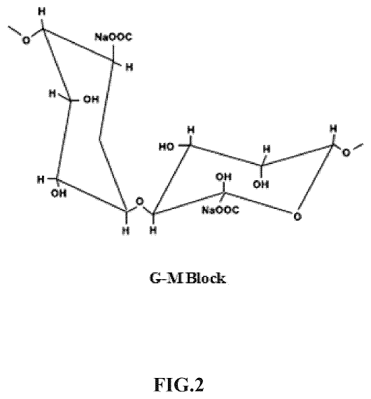

FIG. 3. “Egg-box” configuration after chelation with divalent cation.

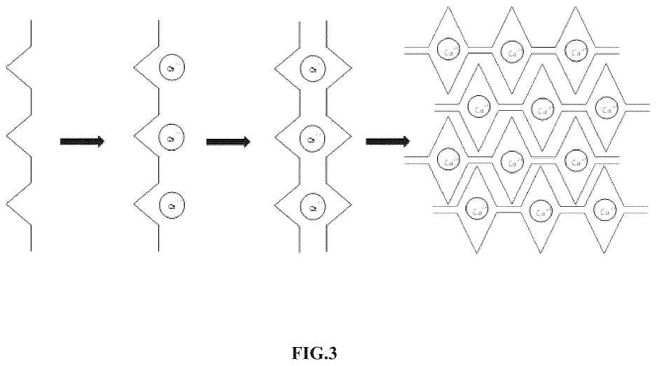

FIG. 4. Hydrated calcium alginate layer schematic.

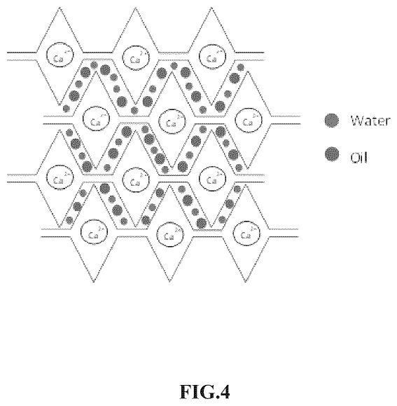

FIG. 5. Schematic of extended-release fertilizer manufacture.

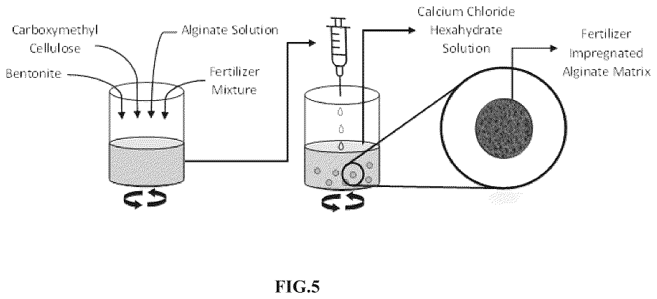

FIG. 6. Fertilizer release mechanism.

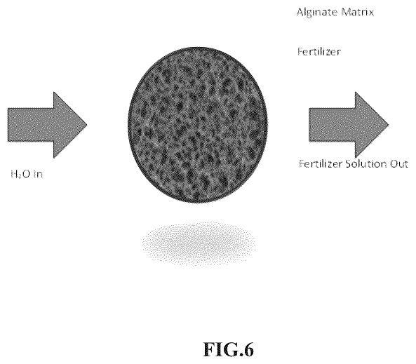

FIG. 7. Water flow schematic of extended-release fertilizer in plants.

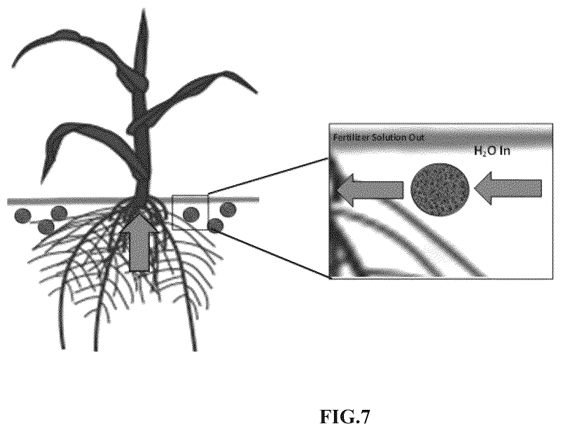

FIG. 8. Schematic of evaporation schematic of essential oil encapsulation.

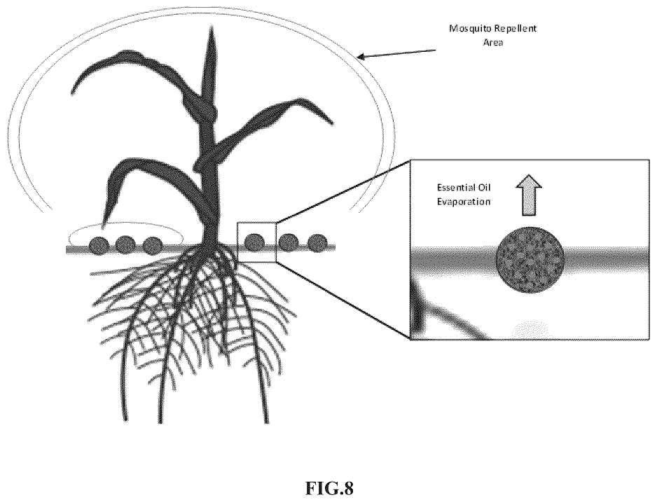

FIG. 9. Schematic of essential encapsulation manufacture.

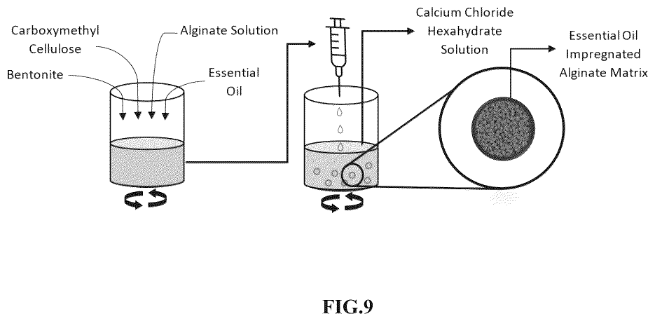

FIG. 10: Week 0 soil test results: (a) Nitrogen test (b) Phosphorus test (c) Potassium test.

FIG. 11 (a) Dehydrated capsules of sample B003, (b) the same samples rehydrated in DI water.

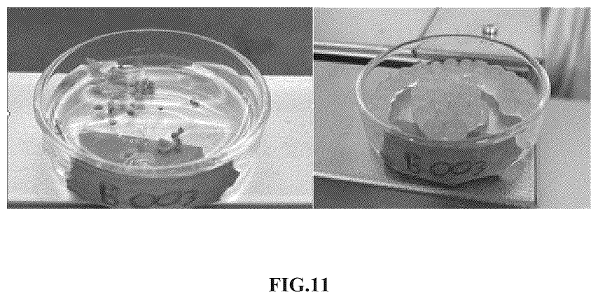

### DETAILED DESCRIPTION

The invention described here in enables the emulsion synthesis, processing and end-product of alginate encapsulated fertilizer and oil sponges with none, one, all, or any combination of additives (namely: clay, calcined clay, bentonite clay, carboxymethyl cellulose, sodium polyacrylate), whether the fertilizer is in solid or liquid form, or the oil is unrefined, refined or a combination of oils and their compositions of matter. It is clear to an artisan in the field of encapsulation of fertilizers and oils using alginate or other gelling media, that the present invention described here-in may be performed with any nonpolar “oil” chemicals whether hydrocarbons or lipids and their constituents (proteins, waxes), or any fertilizing salt, whether being is solid form or dissolved in liquid, so long as a stable emulsion is produced and proper chelation techniques are employed.

On the first step, a low concentration (0.1-10.0 wt. %) sodium alginate aqueous solution is mixed at room temperature until complete dissolution. Post dissolution, the fertilizer mixture is added and vigorously mixed, in another embodiment the oil is added slowly with gentle stirring until complete emulsification. The fertilizer mixture and stable emulsion are then extruded though a syringe, pipette, or pumping vessel and added drop wise into a mildly concentrated divalent cation solution (i.e.: Calcium Lactate, calcium chloride, etc.), and stirred until complete chelation. The fertilizer and oil loaded sponges are strained from the chelation solution and are prime embodiments of the present invention. The sponges may then be rinsed with DI water and processed in different manners.

In one embodiment of the invention the prepared oil capsules are processed by oven drying (temperature) and then sealed packaging for storage. Sponges prepared as such would be ideal for insect repellency applications which require leaching of oil in the air. In another embodiment of this invention, the fertilizers capsules are stored before the drying step. In a similar embodiment for controlled fertilizer release, clay minerals such as but not limited to those of the smectite, fullers earth, kaolin, mica group are included in the mixing and emulsion step at (0.1-50 wt. %) for their adsorption and wettability. In all these examples, dispersion of oil with various hydrophobic and lipophilic constituents in a homogenous alginate gel enables no phase segregation.

In similar yet advanced embodiments of the present invention, one, all or any combination of calcined clay (0.1-50 wt.), clay (0.1-50 wt.), cellulose (0.1-50 wt.), carboxymethyl cellulose (0.1-50 wt.), may be included as additives for enhancing porosity, fertilizer adsorption, and encapsulation structure. Cellulose, clay, and calcined clay materials swell and interact via hydrogen bonding with alginate allowing water to enter and exit the capsules indefinitely. Furthermore, clays of the smectite group exhibit porosity available for absorption of oils whether lipophilic or completely non-polar. Many types of cellulose may be employed without deviating from the scope of the present invention: plant derived cellulose, bacterial cellulose; other biologically derived or modified cellulose (methyl cellulose, carboxymethyl cellulose, sodium carboxymethyl cellulose, hydroxypropyl methyl cellulose, ethyl cellulose, ethyl hydroxyethyl cellulose, ethyl methyl cellulose, cellulose acetate, cellulose, nitrocellulose, cellulose sulfate, etc.). Many types of clays may be used without deviating from the scope of the present invention: montmorillonite, bentonite, palygorskite, kaolin, mica, etc.

Preliminary controlled release fertilizers result: To create a more environmentally friendly solution to current fertilizer products through the use of biodegradable materials and the idea of Controlled Release Fertilizer (CRF).

Throughout this process, a couple different procedures were undertaken in order to first produce a potential fertilizer capsule product, and then test the manner of release in soil. The first procedure was the actual production of the fertilizer capsules, and required much iteration. The primary materials used for this process were DI Water, Miracle Gro Liquid Fertilizer, sodium alginate powder, bentonite clay, cellulose powder, sodium polyacrylate powder, and calcium chloride hexahydrate in solution. These various materials all served different purposes, the most important being the fertilizer, sodium alginate powder, and calcium chloride hexahydrate solution. The liquid fertilizer was necessary as a way to test the release of it within the alginate capsules in the newly formed packages. When mixed with the alginate powder, the mixture thickens and reacts with divalent ions, in this case calcium. When in the presence of calcium, the alginate will allow the mixture to form a gel, the properties of which can be controlled by the amount of both alginate and calcium. The remaining materials, bentonite clay, cellulose powder, and sodium polyacrylate powder, were all used as additional mix-ins to the solution to alter the structure beneficially. These ingredients were all mixed together many times in different amounts according to Table 1.

TABLE 1
Fertilizer solution sample compositions

| Sample | Fertilizer | Water | Sodium | Cellulose | Bentonite | Sodium |
|---|---|---|---|---|---|---|
| # | (mL) | (mL) | Alginate (g) | (g) | Clay (g) | Polyacrylate |
| 001 | 50 | 50 | 1.5 | 0.75 | 0.75 | 0 |
| 002 | 50 | 50 | 1.5 | 0.75 | 1.5 | 0 |
| 003 | 50 | 50 | 1.5 | 0.75 | 0.75 | 0.25 |
| 004 | 50 | 50 | 1.5 | 0.5 | 0.75 | 0.5 |
| 005 | 100 | 0 | 1.5 | 0.5 | 0.75 | 0.5 |
| 006 | 100 | 0 | 1.5 | 0.75 | 0.75 | 0 |
| 007 | 100 | 0 | 2 | 0 | 2 | 0 |
| 008 | 100 | 0 | 2 | 0 | 2 | 0 |
| 009 | 100 | 0 | 1.5 | 0.75 | 0.75 | 0 |
| 010 | 100 | 0 | 2.5 | 0.75 | 0.75 | 0 |
| 011 | 100 | 0 | 2.5-4 | 1.5 | 0.75 | 0 |
| 012 | 100 | 0 | 1.5 | 0.75 | 0.75 | 0.75 |

Once each fertilizer solution was made to be homogenous using an overhead mixer, they were placed in a separatory funnel to be transferred to a 1% calcium chloride hexahydrate solution dropwise. The calcium solution was placed on a magnetic stirrer with a stir bar placed inside in order to form perfect sphere drops as the fertilizer mixture dropped into the solution. As the drops fell into the solution, the alginate and calcium would begin to form a thin gel film around the droplet and solidify the fertilizer capsule. These droplets were left overnight in order to ensure a homogenous gel throughout each capsule, and strained out of the solution the next day, washed with DI water and set at 60° C. to dehydrate. This was a way to test the fertilizer release as they dry, and then these samples were placed in DI water to test their rehydration ability.

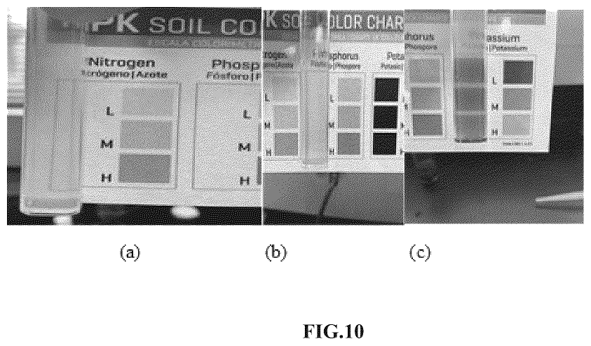

Alongside the iteration of different compositions of fertilizer solutions and capsules, soil testing was done to ensure the fertilizer would actually release from the capsules. To test this, a LaMotte NPK soil testing kit was used on soil found from outside. First, a test was done on the soil before fertilization, and it was found that the soil was very low in nutrients, specifically nitrates, phosphorus, and potassium, as shown in FIG. 10. Following these tests, four cups of the soil were prepared with 10 g samples of sample 001, 002, 003, and 004 (as shown in Table 1) respectively. These were left to allow the capsules to dry out into the soil before watering about every 2 days. Once dried out, it was noticed that the capsules were not fully rehydrating. Soil testing was done twice, every 2 weeks, and results were recorded, looking for increases in nutrients to confirm the ability to release the fertilizer from within the capsules. These results were recorded below in Table 2.

TABLE 2
Qualitative soil testing results from at weeks 0 (before fertilizer
added), 2, 4, and 6 for relative amounts of nitrogen, phosphorus,
and potassium added by capsule samples 001, 002, 003, and 004.

| | 1 | | | 2 | | | 3 | | | 4 | | |
|---|---|---|---|---|---|---|---|---|---|---|---|---|
| | N | P | K | N | P | K | N | P | K | N | P | K |
| Week | Low | Low | Low | Low | Low | Low | Low | Low | Low | Low | Low | Low |
| 0 | | | | | | | | | | | | |
| Week | Low | Med | High | Low | Med | Med | Low | Low | Low | Low | Low | Low |
| 2 | | | | | | | | | | | | |
| Week | Low | Med | Low | Med | Low | High | Low | Low | Low | Low | Low | Med |
| 4 | | | | | | | | | | | | |
| Week | Low | Med | High | Low | Med | Low | Low | High | Med | Low | Low | Med |
| 6 | | | | | | | | | | | | |

Through these soil tests, there was a clear increase in the relative amounts of nutrients (nitrogen, phosphorus, and potassium) present in the soil samples as a result of the release of the fertilizer. As the capsules dried out, it was evident that the fertilizer was dispensed into the soil more and more as time passed.

It was observed that the capsules would not rehydrate properly when the soil was watered, which meant the capsules were not as efficient as they could have been. Looking back at the samples, it was realized that sample 006 had the highest rehydration ability and was able to refill almost all of the water it had lost when left in DI water after dehydration. The composition of 006 was recreated and left to drop in the calcium chloride solution overnight, but when the capsules were strained, rinsed, and dehydrated, they would not rehydrate when left in DI water, indicating that there was some other reason for the original batches' rehydration ability. It was soon discovered that through leaving the fertilizer solutions to drop overnight, the alginate reacts with the calcium significantly more over time, creating more opportunities for chelation of the capsules and a homogenous gel-like substance throughout each capsule. However, when the droplets are removed from the calcium chloride solution soon after being dropped, they only chelate slightly on the surface of the beads, forming a sort of bubble surrounding the fertilizer solution. After this process, it was found that the capsules were extremely more receptive to rehydration following dehydration.

Now having learned the method of rehydration, new samples, B001, B002, B003, and B004, were prepared using the compositions shown in Table 3. These samples were prepared using the same methods of mixing the solid powders into the liquid fertilizer and emulsified to create a homogenous solution that was then added dropwise into a stirring 0.5% calcium chloride solution. However, for these 4 samples, they were taken out almost immediately after the solution had dropped, to prevent full chelation.

TABLE 3
Fertilizer sample solution compositions

| Sample | Fertilizer | Water | Sodium | Cellulose | Bentonite | Sodium |
|---|---|---|---|---|---|---|
| # | (mL) | (mL) | Alginate (g) | (g) | Clay (g) | Polyacrylate |
| B001 | 100 | 0 | 1.5 | 0.5 | 0.75 | 0.25 |
| B002 | 100 | 0 | 1.5 | 0.75 | 0.75 | 0.25 |
| B003 | 100 | 0 | 1.5 | 0.5 | 0.5 | 0.25 |
| B004 | 100 | 0 | 1.5 | 0.75 | 0.5 | 0.25 |

These samples were all prepared and a few capsules from each were placed in petri dishes and set to dehydrate at 60° C. overnight. The dried-out capsules were then placed in DI water and began to rehydrate almost instantly. This rehydration, specifically from sample B003, is illustrated in Figure [11]. Once the rehydration of the capsules is perfected, the compositions will be changed to test for the greatest effect of the fertilizer capsule on soil through more repeated soil tests.

### REFERENCE

1. Grant, G. T., Biological interactions between polysaccharides and divalent cations: the egg-box model. Febs Lett., 1973. 32: p. 195-198.
2. Husemann, E., Chemistry and Enzymology of Marine Algal Polysaccharides. Von E. Percival und RH McDowell. Academic Press, London-New York 1967. 1. Aufl., XII, 219 S., mehrere Abb. u. Tab., geb. 60s. Angewandte Chemie, 1968. 80 (20): p. 856-856.
3. Xiao, D., et al., Strong alginate/reduced graphene oxide composite hydrogels with enhanced dye adsorption performance. Polymer Bulletin, 2020. 77 (12): p. 6609-6623.
4. Velings, N. M. and M. M. Mestdagh, Physico-chemical properties of alginate gel beads. Polymer Gels and Networks, 1995. 3 (3): p. 311-330.
5. Chang, C. P. and T. Dobashi, Preparation of alginate complex capsules containing eucalyptus essential oil and its controlled release. Colloids and Surfaces B: Biointerfaces, 2003. 32 (3): p. 257-262.
6. Chan, E.-S., Preparation of Ca-alginate beads containing high oil content: Influence of process variables on encapsulation efficiency and bead properties. Carbohydrate polymers, 2011. 84 (4): p. 1267-1275.
7. Peniche, C., et al., Formation and stability of shark liver oil loaded chitosan/calcium alginate capsules. Food Hydrocolloids, 2004. 18 (5): p. 865-871.
8. Németh, B., et al., Fully bio-originated latent heat storing calcium alginate microcapsules with high coconut oil loading. Solar Energy, 2018. 170: p. 314-322.

We claim:

1. The synthesis of sponge/capsule preparation for encapsulation of fertilizers in solid or liquid form, and oils with controlled leaching using emulsion techniques using alginate, oil, thickener, nanoparticle additives, a divalent ion.

2. The method of 1 comprised of fertilizers salts and fertilizer solutions including but not limited to urea, diammonium phosphate and potassium chloride, commercial fertilizer mixture.

3. The method of claim 1 is oil comprised on hydrophobic or lipophilic but not limited to essential oils, vegetable oils (peanut oil, sunflower oil, olive oil), paraffins, pharmaceutical oils, plant extract, processed plant-based oils (andiroba oil, copaiba oil, eucalyptus oil, citronella oil, lavender oil, peppermint oil, lemongrass oil) and variety of oils which are not limiting.

4. The method of claim 1, wherein the emulsion occurs from room temperature to as high as 80° C.

5. The method of claim 1, wherein the sponge shape is formed by any vessel used to insert the emulsion into the divalent ion bath or by dripping the emulsion in said bath.

6. The method of claim 1, wherein the calcium ion solution is made from calcium lactate, pure calcium, or calcium chloride, wherein the calcium ions solution is 1-100% saturation or super saturated.

7. The claim 1 sponge is rinsed and freeze dried or stored while still wet, the oil sponges are rinsed dried under room temperature, or in oven, or via freeze drying, or any combination thereof.

8. The method of claim 1, wherein the alginate solution is 0.1-10 wt. %.

9. The method of claim 1, wherein a thickener is sodium polyacrylate (0.01-5 wt. %), carboxymethylcellulose (0.01-5 wt. %), clay (0.01-50 wt. %), calcined clay (0.01-50 wt. %), or a combination of them.

10. The method of claim 1 additives can be clays, calcined clays, smectite group, fullers earth, kaolin group, etc.

11. The method of claim 1, wherein the packaged product is stored under room temperature or in a fridge or freezer.

12. The method of claim 1 is the porous gel structure allows the fertilizer to slowly leech out of the matrix to fertilize the soil, furthermore, allows the entrapped oils to disperse in the air.

13. The methods of claim 1 including dried products and packaged products are biodegradable and non-toxic.

14. The methods of claim 1 containing encapsuled oil in can be applied as mosquito repellent.

15. The methods of claim 1 is that the sponges can be encapsulated multiple times to form different layers for control fertilizer delivery, mosquito repellant to beauty products.
